(19) United States
(12) Patent Application Publication
(10) Pub. No.: US 2014/0149548 A1
(43) Pub. Date: May 29, 2014

(54) METHOD FOR CONTENT DELIVERY IN A CONTENT DISTRIBUTION NETWORK

(71) Applicants: Parminder Chhabra, Madrid (ES); Armando Antonio Garcia Mendoza, Madrid (ES); Arcadio Pando Cao, Madrid (ES); Pablo Rodriguez Rodriguez, Madrid (ES)

(72) Inventors: Parminder Chhabra, Madrid (ES); Armando Antonio Garcia Mendoza, Madrid (ES); Arcadio Pando Cao, Madrid (ES); Pablo Rodriguez Rodriguez, Madrid (ES)

(73) Assignee: TELEFONICA, S.A., Madrid (ES)

(21) Appl. No.: 14/116,804

(22) PCT Filed: May 7, 2012
(86) PCT No.: PCT/EP2012/058397

§ 371 Date: Feb. 4, 2014

(30) Foreign Application Priority Data
May 12, 2011 (ES) P201130755

(51) Int. Cl. H04N 21/231; H04N 21/222

(52) U.S. Cl. CPC H04N 21/23106; H04N 21/2221
USPC 709/217

(57) ABSTRACT

It comprises using buckets as logical containers for content files, and associating meta-data to said buckets, wherein said associating of meta-data comprises the association of two kinds of meta-data: file system meta-data and content distribution meta-data. The latter includes attributes or properties for specific use in a CDN system, and the method comprises using said content distribution meta-data for managing the content delivery in a CDN service.

### FIELD OF THE ART

The present invention generally relates to a method for content delivery in a Content Distribution Network, or CDN, comprising using buckets as logical containers for content files and associating file system meta-data to said buckets, and more particularly to a method further comprising associating content distribution meta-data to the buckets for managing the content delivery through a CDN service.

### PRIOR STATE OF THE ART

Next, some definitions are given that are useful for understanding the terminology used for both, the prior art disclosures and the present invention.

PoP: A point-of-presence is an artificial demarcation or interface point between two communication entities. It is an access point to the Internet that houses servers, switches, routers and call aggregators. ISPs typically have multiple PoPs.

Content Delivery Network (CDN): This refers to a system of nodes (or computers) that contain copies of customer content that is stored and placed at various points in a network (or public Internet). When content is replicated at various points in the network, bandwidth is better utilized throughout the network and users have faster access times to content. This way, the origin server that holds the original copy of the content is not a bottleneck.

ISP DNS Resolver: Residential users connect to an ISP. Any request to resolve an address is sent to a DNS resolver maintained by the ISP. The ISP DNS resolver will send the DNS request to one or more DNS servers within the ISP's administrative domain.

URL: Uniform Resource Locator (URL), is the address of a web page on the world-wide web. No two URLs are unique. If they are identical, they point to the same resource.

URL (or HTTP) Redirection: URL redirection is also known as URL forwarding. A page may need redirection if its domain name changed, if creating meaningful aliases for long or frequently changing URLs, if spell errors from the user when typing a domain name, if manipulating visitors etc. In this case, a typical redirection service is one that redirects users to the desired content. A redirection link can be used as a permanent address for content that frequently changes hosts (much like DNS).

ARL (Alternate Resource Locator): ARL is really a URL with CDN specific data embedded. ARL is a subset of URLs and it is used to direct requests to CDN content servers.

Bucket: A bucket is a logical container for a customer that holds the CDN customer's content. A bucket either makes a link between origin server URL and CDN URL or it may contain the content itself (that is uploaded into the bucket at the entry point). An end point will replicate files from the origin server to files in the bucket. Each file in a bucket may be mapped to exactly one file in the origin server. A bucket has several attributes associated with it—time from and time until the content is valid, geo-blocking of content. Mechanisms are also in place to ensure that new versions of the content at the origin server get pushed to the bucket at the endpoints and old versions are removed.

A customer may create as many buckets as he wants. A bucket is really a directory that contains content files. A bucket may contain sub-directories and content files within each of those sub-directories.

Geo-location: It is the identification of real-world geographic location of an Internet connected device. The device may be a computer, mobile device or an appliance that allows for connection to the Internet for an end user. The IP-address geo-location data can include information such as country, region, city, zip code, latitude/longitude of a user.

Consistent Hashing: This method provides hash-table functionality in such a way that adding or removing a slot does not significantly alter the mapping of keys to slots. Consistent hashing is a way of distributing requests among a large and changing population of web servers. The addition of removal of a web server does not significantly alter the load on the other servers.

Using bucket or a container, as an abstraction of a folder to store content is well understood. However, merely using them as folders with access controls is archaic.

In Amazon, an S3 bucket [2], [3] merely serves as a folder that holds content files. A S3 bucket is created in exactly one region (a physical region US, EU or APAC is associated with a bucket). An object stored in a region resides only in that region but may be accessed from anywhere by an end user. Amazon S3 does not copy or move an object to another region.

In Amazon's S3, a bucket created has the following properties (or meta-data) [3], [4]: Bucket Name, Creation date of Bucket, Bucket Location or region where created, Owner name, Owner id, Versioning Status, Total virtual folder in selected bucket, Total number of files in selected bucket, Total size of bucket, Total number of objects.

These properties (or meta-data) are similar to file-system properties under Unix. In addition, the access to a S3 object is guided by policies that must be explicitly defined via an access control list (ACL). The ACL is designed to allow read, write permissions for everyone, authenticated users and for the owner (or creator) of the bucket and objects in the bucket.

Amazon serves content using Amazon cloudfront (Amazon's version of Content Distribution Network, or CDN). In order to serve content from an S3 bucket, the CDN customer creates a bucket, creates a distribution (which is equivalent to getting URLs for the content that need to be served by the CDN). This interaction is via REST API and using the CDN customer's credentials. The cloudfront infrastructure copies the requested content from the S3 bucket to the edge location and serves the content to the requesting end user.

Decisions on geo-blocking, how long the content in a bucket is valid for distribution by cloudfront are implemented as policies. An example of a policy request is: Deny all requests that originate from USA. Policies are evaluated before the request is made to an S3 bucket. Policies together with ACLs control access to objects in cloudfront.

Amazon cloudfront distribution supports only HTTP objects or streaming distributions (RTMP). In addition, RTMP variants (RTMPE, RTMP,T RTMPTE) are also supported. Currently, cloudfront does not support live-streaming of content.

Both Amazon cloudfront and Akamai use validity of content as part of the URL (Akamai refers to it as ARL—Akamai Resource Locator [1] and Cloudfront generates this when creating a distribution). So, the buckets are merely folders with access controls.

Currently, several companies including Amazon [2] and Akamai [1] use the notion of a bucket as a folder to store data. By associating access control over the buckets, they allow for data in a bucket to be shared among a selected group of users or make the bucket public.

When used for content delivery, merely associating access control at the bucket level is insufficient since any content delivery infrastructure needs a lot of additional information about the bucket before it can serve content from a bucket.

At the present time, the state of art for associating meta-data with content is based on one or more of the following concepts: Meta-data is part of the request string itself. While this is useful in quickly resolving the servers that contain the content (since all of a customer's data resides in one bucket), the number of meta-data fields is limited since the resource locator (e.g. Akamai Resource Locator (ARL), a URL to locate CDN content) can be only so long. Further, this scheme is inflexible should the CDN customer want to associate new meta-data with the content or change any of the meta-data (or the CDN administrator has to change the URL for every change in meta-data). It is considered the following example of such an ARL 0: <cdn-endhost>/<customer_id>/<meta-data>/content. Here, content may be the name of the jpg or video file. The meta-data is received from the origin server in response to a request for the content. This implies that a subsequent request has to be made for the content, which requires another level of indirection. For cloudfront, every request to a new edge implies that the edge gets content from the same S3 bucket. Content of an S3 bucket reside only in the region in which the bucket is created. The S3 bucket in Amazon has file-system like meta-data. A meta-data configuration file is created per-bucket. While this is useful, it is not sufficiently granular to address several issues. Two files from the same customer may need to be served at different rates depending on content (High Definition content will need to be served at a higher rate), content from a customer may be served to end users in certain geographic areas of the world and not others. Meta-data configuration files are distributed to CDN content servers. While this may appear to be a simple solution, it has the overhead of every server maintaining several configuration files and synchronizing them to ensure consistency. Again, these configuration files are per-customer.

U.S. Pat. No. 7,240,100 discloses a method for associating metadata to a given piece of content to be delivered through a CDN, said meta-data being located in a metadata configuration file distributed to CDN servers, or in a per-customer metadata configuration file. The meta-data associated by the method of U.S. Pat. No. 7,240,100 is only of a file-system type.

U.S. Pat. No. 7,647,329 and U.S. Pat. No. 7,739,239, disclose storing data as objects within buckets, each of said objects being comprised of a file and optionally any metadata that describes that file. To store an object according to said patents, one must upload the file he wants to store to a bucket. When one uploads a file, he can set permissions on the object as well as any metadata. For each bucket, one can control access to the bucket (who can create, delete, list objects, etc.). U.S. Pat. No. 7,647,329 and U.S. Pat. No. 7,739,239 only disclose associating file-system meta-data.

All the above schemes are very rigid in terms of how they treat meta-data. The meta-data is not sufficiently granular (it is per-customer or per-bucket rather than per-file), cumbersome to work with for a CDN customer and prone to maintenance overhead. Also, the associated meta-data of said disclosures is only of a file-system kind.

### DESCRIPTION OF THE INVENTION

It is necessary to offer an alternative to the state of the art which covers the gaps found therein, particularly those related to the rigidity meta-data associated to buckets is treated in the above cited disclosures.

To that end, the present invention provides a method for content delivery in a CDN, comprising using buckets as logical containers for content files, and associating file system meta-data to said buckets, wherein, differently from the known proposals, the method further comprises, in a characteristic manner, associating content distribution meta-data to said buckets, said content distribution meta-data including attributes or properties of specific use for a CDN system, and using said content distribution meta-data for managing the content delivery through a CDN service.

The buckets created and used according to the method of the invention are named in the present description as intelligent buckets.

For an embodiment, the method comprises generating automatically said file-system meta-data when a bucket or a content file in a bucket is created.

While said file-system meta-data are similar to file attributes of any file system (such as an operating system), the content distribution meta-data are attributes or properties of specific use for a CDN system, i.e. they are an inherent property of the buckets and hence, they give such buckets, intelligence for use in a CDN.

Depending on the embodiment, the method comprises associating said file system meta-data and said content distribution meta-data with each file of each bucket, including said content files, and/or with each bucket.

The method comprises, preferably, creating said intelligent buckets with content distribution as the sole application.

In general, the method comprises carrying out said content delivery through said CDN, to an end user, using said associated meta-data to guide said content delivery, thus giving to the CDN customer, by means of associating meta-data for content delivery for a bucket and with each file in a bucket, flexibility in how to treat meta-data for each file.

Other embodiments of the invention are described in appended claims 7 to 17, and in a subsequent section related to the detailed description of several embodiments.

For the present invention, in the service provider's CDN, an intelligent bucket is a logical container for a customer to store data in a CDN.

### BRIEF DESCRIPTION OF THE DRAWINGS

The previous and other advantages and features will be more fully understood from the following detailed description of embodiments, with reference to the attached drawing, which must be considered in an illustrative and non-limiting manner, in which:

FIG. 1 shows the interaction between a CDN client and the service provider's CDN infrastructure according to an embodiment of the method of the invention. The bucket created by a CDN customer is synchronized between the entry point and the tracker and between the tracker and the end points.

### DETAILED DESCRIPTION OF SEVERAL EMBODIMENTS

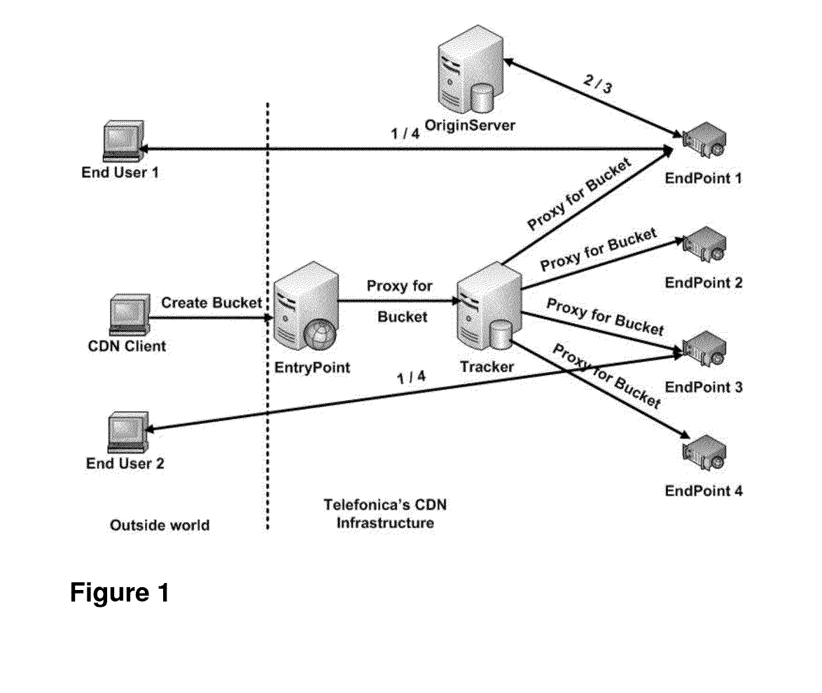

First, a brief description of each component of the service provider's CDN system illustrated by FIG. 1 is given. The illustrated infrastructure consists of Origin Servers, Trackers, End Points and Entry Point. This is part of the service provider's CDN infrastructure that is used by buckets.

Entry Point (Publishing point): Any CDN customer may interact with the CDN infrastructure solely via the entry point. The entry point runs a web services interface with users of registered accounts to create/delete and update buckets.

A customer has two options for uploading content. The customer can either upload files into the bucket or give URLs of the content files that reside at the CDN customer's website. Once content is downloaded by the CDN infrastructure, the files are moved to another directory for post-processing. The post-processing steps involve checking the files for consistency and any errors. Only then is the downloaded file moved to the origin server. The origin server contains the master copy of the data.

CDN Manager: The CDN manager hosts the Content Manager API, the DNS API and the Network Topology API (all APIs are on this server). There is one instance of the CDN manager for the entire CDN. The CDN manager may reside at one of the entry points (publishing points) or in a separate server.

End Point: An end point is the entity that manages communication between end users and the CDN infrastructure. It is essentially a custom HTTP server.

Tracker: The tracker is the key entity that enables intelligence and coordination of the CDN infrastructure.

Origin Server This is the server(s) in the CDN infrastructure that contains the master copy of the data. Any end point that does not have a copy of the data can request it from the origin server. The CDN customer does not have access to the origin server. Telefonica's CDN infrastructure moves data from the ftp server to the origin server after performing sanity-checks on the downloaded data.

The service provider's CDN infrastructure uses intelligent bucket as an abstraction for storing and delivery of a CDN customer's content. At the service provider's CDN, all buckets are of type managed. Content for buckets of type managed is controlled entirely by the CDN. For the managed bucket type, the service provider's CDN allows for the creation of two kinds of buckets (although the method is not limited to only said two kinds of buckets): VoD and Live Streaming. Both buckets have associated with them, file-system type meta-data and meta-data that controls content delivery.

A VoD bucket by definition is on demand and may store any kind of content (the format of the file may be of any type). The end points that serve the content in the bucket if the end point can serve the kind of content specified in the file types in the bucket. So, a VoD bucket may serve HTTP objects, RTSP, RTMP, MMS etc. The VoD bucket may also use a variety of delivery mechanisms including RTMP, smooth streaming and iphone streaming. A VoD bucket does not place any restriction on the kind of media file or the delivery mechanism for the file.

A live bucket is created to stream live content. A live bucket may serve any live media stream over any delivery mechanism.

The CDN end points serve the content requested by end users. However, the rest of the CDN infrastructure, the entry point where the intelligent bucket is created and the tracker that synchronizes the bucket meta-data with the entry point periodically only serve as a proxy to the bucket for the CDN infrastructure.

In the service provider's CDN, a CDN customer may interact with the CDN infrastructure only at the entry point. It is first described how to set the properties of a bucket; add content to a bucket and finally, how to associate meta-data with files in a bucket that makes the bucket intelligent for use in content delivery in the CDN infrastructure.

Any CDN customer may create a bucket at the entry point. The bucket has meta-data that is both of file-system type and for content-delivery.

The fields in file system meta-data are: bucket_id, name, enabled, date_created and last_modified, last_accessed. The rest of parameters are associated with content distribution.

The following parameters may be associated with a bucket when a bucket is created. What is listed is the name of each parameter, its type and also if it is needs to be defined at the bucket creation time. A number of fields are optional. Some of the fields may be assigned a default value when a bucket is created.
name: bucket_id, type: long, optional: no. This field is a globally unique bucket identifier. The CDN Manager assigns this value to a bucket. A bucket id is globally unique.
name: name, type: string, optional: no. This field is the name of the bucket object. So, a customer can give a meaningful name to the bucket.
name: enabled, type: integer, optional: no. This filed indicates if the bucket is enabled. A value 1 implies that the bucket is enabled, while 0 implies that it is not (which implies that the bucket does not exist).
name: date_created, type: long, optional: no. This field indicated the date and time when the bucket was created.
name: last_modified, type: long, optional: no. This field is set automatically. This indicated the last time that the bucket meta-data was modified.
Name: last_accessed, type: long, optional: no. This field is set automatically. This field indicates the last time that any file in the bucket was accessed by an end user.
name: managed, type: integer, optional: no. If a bucket is managed (value=1), then the origin server is the CDN's origin server. Else, content must be downloaded from the CDN customer's server (value of managed=0). The address of the server is in the field sourceurl.
name: originserver, type: string, optional: no. This field is the URL prefix of the origin server that is part of the CDN infrastructure. This is assigned by the CDN infrastructure.
name: sourceurl, type: string, optional: yes. This field contains the URL of the server where the files for this bucket are stored at the customer premises. The CDN infrastructure gets the content from this URL. This field is empty if the bucket is managed.
name: bandwidth, type: integer, optional: no. This field gives the maximum rate at which a file in this bucket should be delivered to a requesting end user in Kbytes/s. If a value of zero is used, the file is served at the maximal rate by the end points.
name: live, type: integer, optional: no. This field indicates if the bucket is for live broadcast or for VoD. A value 1 implies that content in the bucket is live content. On the other hand, a value of 0 implies that the bucket contains content for VoD.
name: bucket_contint, type: string, optional: yes. This field contains the URL of a file that has the SHA1 of all the content files in the bucket.
name: startdate, type: long, optional: yes. This field signifies the time when the content of the bucket will become available (in seconds since 1970-01-01 00:00:00 UTC)
name: enddate, type: long, optional: yes. Time when the content of the bucket will not be available (in seconds since 1970-01-01 00:00:00 UTC)
name: geoloc, type: Array<string>, optional: yes. This is a comma-separated list of country codes where the content of the bucket is valid. This is useful in geo-blocking of end user requests.
name: geolocinv, type: string, optional: yes. This is the URL of a custom html file that should be sent in the event of a geo-location failure (content cannot be distributed to the country/region of the requesting user).
name: referrer, type: string, optional: yes. This is the http address of the website that directed the requesting end user to get content from the CDN infrastructure. The end points will serve data to a requesting end user only if the request comes from the CDN customer's domain.
name: host, type: string, optional: yes. This field is the hostname. It is useful if multiple websites are run on the same CDN node.
name: qos, type: integer, optional: yes. This field indicates the QoS of files in the bucket.
name: size, type: string, optional: yes. This field indicates the size of the bucket. It has two possible values, large and small. A reason to distinguish the size of a bucket is that it is easy to cache small objects.
name: deliverytype, type: list, optional: no. This field identifies the type of content. 0: http native, 1: rtmp native, 2: rtmp, 3:smooth streaming, 4: iphone streaming, 5: rtsp, 6: rtmpe, 7: rtmpt. As additional delivery types come about, this field will be used to define the delivery type. Multiple delivery types may be defined all at once.
name: multibitrate, type: boolean, optional: yes. This field indicates if multi-bitrate support. This allows the CDN to deliver content to end users at a bit-rate that matches the end user's connection speed. This is especially useful for live-streaming where the CDN must adapt quickly to changing network conditions.
name: smil, type: string, optional: yes. This field is useful only if multibitrate is set to true. A SMIL (Synchronized Multimedia Integration Language) file [1] [5] is based on XML consists of tags that are case sensitive. All SMIL tags require lowercase letters.
   a. As an example, it is shown how one may set the CDN to deliver multi-bitrate streams of 100 Kbps and 350 Kbps as part of the definition of a live bucket.

```
  {
    “multibitrate”: true,
    “smil”:“<smil><head></head><body><switch><video
src=‘rtmp://10.95.103.227:1935/live-origin/live_multi1’ system-
bitrate=‘100000’/><video src=‘rtmp://10.95.103.227:1935/live-
origin/live_multi2’ system-bitrate=‘350000’/></switch></body></smil>”
}
```

name: preposition, type: unit, optional: yes. This field indicates the time (Unix or Posix time) when content prepositioning should start.
name: prepositioncc, type: string, optional: yes. This field is a comma-separated list of country codes for content prepositioning. This is ignored if preposition field is set to 0.
name: whitelist, type: string, optional: yes. Comma separated list of subnets that are in the whitelist.
name: blacklist, type: string, optional: yes. Comma separated list of subnets that are in the blacklist.
name: seektype, type: string, optional: yes. This field defines the format of the query string associated with video seek requests on a requested file by an end user.
name: autoseekinfo, type: boolean, optional: yes. This field tells the end point to build pre-built seek tables. If the field is set, it allows the end point to process requests of the kind http://endpoint/mp4file.mp4?start=210. Here, the end user wishes to start the stream from the time point 3 min and 30 sec (or 210 sec) from the start of the media file. With pre-computed tables at the end point, the starting time, corresponding offset and headers, the creation of the binary files for the end user is much less demanding.
name: authentication, type: object, optional: yes. This field defines the different types of authentication a content owner may want to support for all content in the bucket. So, every request for content will be authenticated as requested by the content owner. This is flexible to include any authentication mechanism between the content owner and elements of the CDN. Depending on the type of authentication, the object will have different field types.
name: orig_authentication, type: object, optional: yes. This is used for origin server authentication. This field is of type object and has parameters username and password of the origin server. This forces every request for the content to be authenticated by the origin server.

Having created a bucket, the CDN customer can upload content to the bucket. Next, is disclosed how to define a live bucket and additional fields that may be needed.

### Live Bucket:

If the content in the bucket is live, i.e. is a live streaming bucket, the bucket has additional meta-data associated with it.
name: sourceurl, type: string, optional: no. This field is the URL of the stream source that the CDN used to get the live stream. The CDN must then use this live feed to serve the requesting end users.
name: livesplitter, type: string, optional: no. This field has the IP address and port number of the live splitter (IP_address:port). This CDN infrastructure uses the live-splitter and segmenter at the live-stream to build a playlist to serve the live stream.
name: segmentduration, type: uint, optional: yes. This field represents the duration in seconds of each segment of the live stream. This is already assigned a value by the CDN infrastructure.
name: playlistsize, type: uint, optional: yes. This field represents the size of the playlist. The duration of the playlist is the size of the playlist*segment duration. This value is set by the CDN.

All of the other fields like whitelist, blacklist, geoloc, startdate, enddate and authentication may be defined just as in a VoD bucket.

A live bucket is treated differently from a VoD bucket. A live splitter in the CDN infrastructure gets the live stream from the content owner. A segmenter at the live splitter breaks the stream into segments. The live splitter then builds a playlist from these segments and forwards the playlist to the end point. The live splitter periodically updates the playlist. Thus, the end point infers the playlist as content arriving from an origin server in the CDN infrastructure. This content is then served to requesting end users.

Once a bucket is created, its meta-data may be updated/modified via a REST interface.

### Adding Content to a CDN VoD Bucket and Associating Meta-Data to Files:

Next a detailed description of the association of meta-data with files in a VoD bucket is given. Said description is also valid for other embodiments for which the data to be delivered is other different to video data. It is also explained how a CDN customer may add files into a VoD bucket. Every file in a VoD bucket has additional file-level parameters that need to be defined. Next, such fields will be defined.

A customer has two options for uploading content. The customer can either upload files into the bucket or give URLs of the content files that reside at the CDN customer's website. Once content is downloaded by the CDN infrastructure, the files are moved to another directory for post-processing. The post-processing steps involve checking the files for consistency and any errors. Only then is the downloaded file moved to the origin server. The origin server contains the master copy of the data.

At the entry point, once content has been downloaded, a requests.xml file is automatically created. This file has meta-data associated with every file that a CDN customer puts into the bucket. A monitoring process looks for the existence of requests.xml file for the post-processing steps discussed above. A CDN customer can overwrite any of the bucket parameters for a file by calling the file API using a REST interface (or using a user-friendly interface) at the time of uploading a file or at any time thereafter. There are additional file parameters that need to be defined.
name: reqid, type: long, optional: no. This field is a globally unique transaction id.
name: method, type: string, optional: no. This field identifies the action associated with a file in the bucket. The allowed values for this are add_file, remove_file and update_file to add, remove and update a content file with a new version respectively.
name: callbackurl, type: string, optional: yes. This is the callback URL that a CDN customer can provide to the CDN infrastructure. This monitor process will invoke this URL with a set of name=value pairs in the query string once the xml block is processed.
name: callbackmethod, type: string, optional: yes. By default, the GET method is invoked. A customer can decide if she wants a POST instead.
name: fileName, type: string, optional: no. This field indicates the name of the file.
name: fileSize, type: long, optional: no. This field indicates the size of the file.
name: fileurl, type: string, optional: yes. This field is used when the CDN customer wants the CDN infrastructure to download the content from servers that are part of CDN customer's infrastructure.
name: username, type: string, optional: yes. This field is used only if the CDN customer wants the CDN customer to download content from servers that are part of the CDN customer's infrastructure.
name: passwd, type: string, optional: yes. This field is used only if the CDN customer wants the CDN customer to download content from servers that are part of the CDN customer's infrastructure.
name: filehash, type: string, optional: yes. This field is the SHA1 of the content media file. The CDN customer provides this value. This allows the CDN infrastructure to ensure the integrity of a file upon download.

Once the monitoring process detects that all files referenced in the xml file are present (and have the right size), the files are moved to another directory for post-processing. This step involves checking the files for consistency and any errors.

When files are uploaded to a bucket, the following meta-data fields inherited from the bucket must also be modified as needed: enabled, startdate, enddate, geoloc, deliverytype, bandwidth, blacklist, whitelist, and authentication.

This allows the content owner to have full control over the geographic area where the content is distributed, the mode of delivery and also the bandwidth at which the file must be delivered. The only requirement is that the bandwidth at the bucket level must be greater than or equal to the bandwidth set at the file level.

In addition, the geoloc field may be modified at the file level to ensure that countries in which a file is valid is a subset of the countries in which a bucket is valid. So, if a bucket is valid in [es, br, us, uk], every file in such a bucket must be valid in a subset of [es, br, us, uk].

The file-based interaction mechanism proceeds as follows. The file is a collection of <cdnrequest> xml blocks. Each block has one value for method=“add_file|remove_file|update_file”. A user logs into the FTP account and uploads a file called requests.xml. We first consider the case that the CDN customer uploads requests.xml and the content file. The format of requests.xml file is:

```
<!-- sample add_file request -->
<add_file>
  <reqid>100</reqid>
  <fileName>demo-output.flv</name>
  <fileSize>2941018</fileSize>
  <enabled>true</enabled>
  <validfrom>2010-03-01T00:00:00</validfrom>
  <validuntil>2010-12-31T23:59:59</validuntil>
  <filehash>214a1e4eade7b9662184e24377256706dd81e859</filehash>
  <callbackurl>http://cdncustomer.com/callmehere</callbackurl>
  <callbackmethod>GET</callbackmethod>
</add_file>
```

Once the uploaded content is processed, it is assigned a CDN URL. In the above example, if the bucket id of the user was 87, the content URL is http://87.t-cdn.net/87/demo-output.flv. Once this occurs, a callback is executed to the URL http://cdncustomer.com/callmehere/result?reqid=100&name=demo-output.flv&result=0.

Next, the inventor considers the case that the user FTPs requests.xml file alone into the bucket. In such a case, the requests.xml file will be written as:

```
<!-- sample add_file request -->
<add_file>
  <reqid>100</reqid>
  <fileName>demo-output.flv</name>
  <fileSize>2941018</fileSize>
  <enabled>true</enabled>
  <validfrom>2010-03-01T00:00:00</validfrom>
  <validuntil>2010-12-31T23:59:59</validuntil>
  <fileurl> http://www.cdncustomer.com/video/</fileurl>
  etc.
</add_file>
```

The entry point will then download the file from the CDN customer's web server. The entry point will build the URL from the parameters fileurl and the fileName. Once the entry point has downloaded the file, it is processed and assigned a CDN URL as before. The processing of the file (after it is downloaded) generates hashes for each file at the block level (1 Kbyte) so that content integrity at the block level can be verified on any end points prior to distributing the content. These hashes (at the block level) are also stored in the CDN customer's bucket.

The origin server at the CDN has all the files that are part of requests.xml. Two methods by which a client can download content to the CDN infrastructure where the CDN provider manages the buckets have been described above.

The methods remove_file and update_file are defined as follows.

```
<!-- sample remove_file request -->
<remove_file>
  <reqid>101</reqid>
  <fileName>file1.flv</fileName>
  <callbackurl>http://cdncustomer.com/callmehere</callbackurl>
  <callbackmethod>GET</callbackmethod>
</remove_file>
```

Here, the file1.flv is to be removed from the bucket. Once the removal of the file from the bucket succeeds, a callback is executed at the end point with the following URL: http://cdncustomer.com/callmehere/result?reqid=101&name=file1.flv&result=0.

Finally, looking at the format of update_file method it has to be noted that the version of the content itself can't be updated. Rather, this is a way of updating the optional parameters of a file. This method may be used if the content can be shown in other countries, longer or shorter duration. Note in this example that the validity of the demo-output.flv was changed from 2010-12-31 to 2011-12-31.

```
<!-- sample update_file request -->
<update_file>
  <reqid>102</reqid>
  <fileName>demo-output.flv</fileName>
  <enabled>true</enabled>
  <validfrom>2010-03-01T00:00:00</validfrom>
  <validuntil>2011-12-31T00:00:00</validuntil>
</update_file>
```

After processing the files, the monitoring process generates a responses.xml file in the same directory.

There are additional file parameters that need to be defined. These parameters are:
name: status, type: integer, optional: no. Each method in the requests.xml file will have a corresponding status in the responses.xml file. A status code 0 indicates success while a status code of 1 indicates failure.
name: cdnurl, type: integer, optional: no. This field tells the CDN customer the URL that the customer should use when referring to the content file that is now in the CDN infrastructure.

```
<!-- sample add_file response -->
<addfile>
  <reqid>100</reqid>
  <name>output.flv</name>
    <status>0</status>
    <cdnurl>http://87.t-cdn.net/87/file1.flv</cdnurl>
</addfile>
```

The CDN customer can download the responses.xml file when it is available. It has to be noted that the response id is the same as the id in the requests.xml file to indicate that the responses.xml file is in response to the requests.xml.

FIG. 1 summarizes the interactions between a CDN customer and the service provider's CDN infrastructure. This example has four end points. A CDN customer can create buckets and modify meta-data for the bucket at the entry point. Subsequently, the service provider's CDN infrastructure maintains consistency by propagating changes in a customer's bucket to the end points. The synchronization of bucket and meta-data between the entry point and the end point occurs in a few seconds. Likewise, any change in meta-data of a file upon uploading a file is reflected at the end points in a few seconds.

Different components of the CDN, the tracker and the entry point serve a proxy for the meta-data of a bucket and files in a bucket. The meta-data that guides the content delivery comes into play at the end points. Here are described the steps shown on the FIG. 1:
The end user 1 (EU1) makes a request for content and end point 1 is chosen by the CDN infrastructure as being best positioned to serve the content. So, EU1 attempts to connect directly to end point 1 (EP1). Likewise, EU2 requests content from EP3.
The EP1 does not have the content locally. Since neither do its neighbours, it sends a content request for requested content to the origin server.
The origin server sends the requested content to EP1 (the origin server always contains a master copy of the content). Labels 2 and 3 are not shown for EP3 since it has a copy of the requested content locally.
The end points EP1 and EP3 serve content to EU1 and EU2 respectively. The content served is guided by the meta-data parameters of the requested file and bucket.

### Setting QoS:

The flexibility of the method of the invention allows setting bucket level parameters per customer. It can be set:
1. QoS of a customer. We can set different QoS levels for different customers.
2. QoS for a customer bucket.
3. Set QoS for individual files in a bucket.

### Physical Location of the Bucket

A CDN customer at any location may create a content delivery bucket. Once a bucket is created and content uploaded to the CDN infrastructure's origin server, the meta-data is associated with the bucket. This, however, has no meaning until and end user requests content that is in the service provider's CDN. Once an end point comes up, the content meta-data is proxied to the end point. When an end point gets a content request from an end user, the end point first gets the content from the origin server (and in some cases, its neighbours in the same datacenter). The end point then serves the content request. The content served is guided by the meta-data of the bucket and the requested file.

Any change in meta-data of the bucket by a CDN customer is reflected at the end points within a few seconds.

Bucket Size as an Indicator for Caching:

The size of the bucket is a very important parameter in determining how the CDN infrastructure treats a bucket.

The CDN customer may designate a bucket as small. In this case, the bucket object is less than one megabyte in size.

A CDN customer may also designate a bucket as being large. Large buckets have a bucket object that is more than a megabyte in size.

Typically, large bucket objects are delivered via HTTP download while small objects may be cached by the CDN infrastructure.

### Security:

The monitor process at the entry point is responsible for maintaining a filelist.xml file that is associated with every bucket. This file contains name, size and SHA1 of each file in the bucket. Since the tracker synchronizes with the entry point frequently, it also maintains the filelist.xml file for each bucket. Since the end points also synchronize with the tracker regularly, they also have a copy of the xml file.

If an end user makes a request for bogus content, the end point first checks if this content is part of the CDN infrastructure. If it is not, the request is terminated. This ensures that requests for content do not affect the end points that are serving content to other end users. This protects the CDN infrastructure against such attacks.

The invention ensures content integrity both at the block and file level.

In summary, it has been seen how meta-data is associated with a bucket when a bucket a created. It also has been seen how a managed customer bucket can get the content files either via FTP or by allowing the CDN infrastructure to download the content. Meta-data associated with each file can overwrite meta-data at the bucket level giving the CDN customer fine-grained control over for how files in a bucket should be handled.

By providing intelligence to the buckets, customers can use it in a wide variety of ways in the CDN infrastructure, setting QoS, caching, security, geo-location, and validity (time duration for which content is valid) of content, rate at which each content file may be served.

### ADVANTAGES OF THE INVENTION

This invention provides the following advantages:
A CDN customer can assign meta-data to the service provider's intelligent bucket solely for the purpose of content distribution.
A CDN customer can assign meta-data to the files in a bucket either by uploading a xml file that had values for all the fields of interest to the customer or via an easy to use display (in the form of convenient interface) to assign meta data to each file in the bucket.
The CDN customer has full control over the buckets that she creates and any content that is populated in the buckets. So, a CDN customer can set file level granularity for access control of content in a bucket. The bucket level parameters may be overwritten by file level parameters. This allows two files in the same bucket to be served at different rates (one may be a HD file, and hence needs to be served at a higher rate).
Any change in meta-data of a customer bucket or file in the bucket is performed at the entry point. This change is proxied to the end points within a few seconds. The meta-data is meaningful only at the CDN end points.
   1. A consequence of this is that a CDN customer can make changes in the way content is distributed on the fly. So, if a customer would like content to be distributed in Spain, the customer merely adds ‘es’ to the geoloc field of the file.
   2. A CDN customer can decide when the content in a bucket is enabled and when it is disabled. Accordingly, the end point will serve content only if the bucket (and the file) is enabled.
The bucket is assigned parameters that tell a CDN operator if the bucket contains live content or Video-on-demand. This is essential since a live bucket is treated differently from VoD bucket.
A CDN customer can decide what geographic area(s) can the content in a bucket be made available.
A CDN service provider can provide mechanisms that allow buckets of each customer to be offered different levels of QoS.
A CDN service provider can provide mechanisms that allow buckets of two different customers to be treated differently.
The meta-data allows for content pre-positioning so that it becomes available in the end points of geographic region a few hours before the content goes live (end users request for such content is valid).
The intelligent bucket also helps the service provider's CDN in supporting a variety of authentication mechanisms including fast-authentication mechanism with content owners.
The bucket contains parameters that tell a CDN operator the rate at which content in a bucket should be served to an end user. File level parameters tell a CDN operator if two files in the same bucket should be served at different rates.
The filelist.xml file protects the CDN infrastructure against security attacks where bogus content is requested by end users.
This system has the ability the provide block level and file level content integrity, ensuring that the end point verifies content at the block level prior to distributing it to the end user.
The size of a bucket provides the CDN service provider on hints whether to cache the content of the bucket or not.

This invention provides a mechanism within the meta-data that allows the service provider's CDN infrastructure to make intelligent decisions about distributing content from a customer's bucket.

A person skilled in the art could introduce changes and modifications in the embodiments described without departing from the scope of the invention as it is defined in the attached claims.

### Acronyms

ADSL Asymmetric Digital Subscriber Line

CDN Content Distribution Network

DNS Domain Name Service

PoP Point of Presence

TLD Top Level Domain

FTP File Transfer Protocol

HTTP HyperText Transfer Protocol

ARL Akamai Resource Locator

### REFERENCES

[1] Akamai: http://www.akamai.com
[2] Amazon web services: http://aws.amazon.com
[3] Amazon Simple Storage Service (S3) Developer's guide (API Version Mar. 1, 2006), At http://docs.amazonwebservices.com/AmazonS3/latest/dev/
[4] Amazon Cloudfront. Developer's guide (API Version Nov. 1, 2010). Available at http://docs.amazonwebservices.com/AmazonCloudFront/latest/DeveloperGuide/
[5] Synchronized Multimedia Integrated Language. At http://en.wikipedia.org/wiki/Synchronized Multimedia Integration Language

1-16. (canceled)

17. A method for content delivery in a Content Distribution Network, or CDN, comprising using buckets as logical containers for holding content files, and associating file system meta-data to said buckets, wherein the method is characterised in that it further comprises:
associating content distribution meta-data to said buckets, said content distribution meta-data including a list of parameters comprising attributes or properties; and
carrying out the content delivery through a Content Distribution Network (CDN), to an end user, depending on the values of said attributes or properties,
wherein said content is delivered to said end user independently of the geographical region the content was created.

18. A method as per claim 17, comprising generating automatically said file-system meta-data when a bucket or a content file in a bucket is created.

19. A method as per claim 17, comprising associating said file system meta-data and said content distribution meta-data with each file of each bucket, including said content files.

20. A method as per claim 17, comprising associating said file system meta-data and said content distribution meta-data with each bucket.

21. A method as per claim 17, comprising, a CDN customer, adding and/or modifying meta-data associated with each file and/or each bucket.

21. A method as per claim 21, wherein said modification of meta-data includes overwriting meta-data at the bucket level with meta-data associated with each file, for giving the CDN customer a fine-grained control for handling files in each bucket.

23. A method as per claim 21, comprising said CDN customer assigning meta-data to the files in a bucket either by:
uploading a xml file defining parameters that have the effect of assigning meta-data to each file in the bucket;
or
uploading content files into a bucket and using a user interface to associate meta-data for each uploaded file;
or
giving the URL of the origin server in the CDN customer's webserver to download the file and assigning the associated file-level meta-data with the aid of a user interface.

24. A method as per claim 17, comprising the CDN customer performing any change in meta-data of a bucket or file in the bucket at the entry point of said CDN, and proxying said change to the end points of the CDN within a few seconds, said meta-data being meaningful only at the CDN endpoints.

25. A method as per claim 24, comprising, the CDN customer making said meta-data changes for changing the way content is distributed on the fly.

26. A method as per claim 25, comprising, a CDN end point, serving content associated with a bucket only if the bucket and its file or files are enabled for distribution by the CDN customer via corresponding meta-data.

27. A method as per claim 24, comprising: on receiving a content request from an end user, the end point serves the content specified in the request and file type and the said file distribution is guided by the content distribution meta-data of the said bucket.

28. A method as per claim 17, comprising associating meta-data to a bucket indicating the type of contents it contains.

29. A method as per claim 28, wherein said type of bucket content is either one of one of Video On Demand content or content for Live streaming.

30. A method as per claim 17, comprising said CDN customer and/or a CDN service provider, associating file-system and content distribution meta-data to buckets and/or its files in order to at least one of:
deciding what geographic area(s) the content in said bucket can be made available;
providing mechanisms that allow buckets of each customer to be offered different levels of QoS;
providing mechanisms that allow buckets of two different customers to be treated differently;
content pre-positioning so that it becomes available in the CDN end points of a geographic region before said content is requested;
collaborating with the service provider's CDN in supporting at least one authentication mechanism;
telling a CDN operator the rate at which content in a bucket should be served to an end user;
protecting the CDN infrastructure against security attacks where bogus content is requested by end users; and
providing block level and file level content integrity, ensuring that the end point verifies content at the block level prior to distributing it to the end user.

31. A method as per claim 17, comprising, said CDN service provider deciding, depending on the bucket size, whether or not to cache the content of a bucket.
